(19) United States
(12) Patent Application Publication
(10) Pub. No.: US 2026/0109453 A1
(43) Pub. Date: Apr. 23, 2026

(54) SYSTEM FOR TRANSMITTING COMMANDS TO A PLURALITY OF HYDRAULIC SERVO-ACTUATORS

(71) Applicant: SAFRAN ELECTRONICS & DEFENSE, PARIS (FR)

(72) Inventor: Julien HAUTECOEUR, MOISSY CRAMAYEL (FR)

(21) Appl. No.: 19/115,636

(22) PCT Filed: Sep. 20, 2023
(86) PCT No.: PCT/FR2023/051440

§ 371 Date: Mar. 26, 2025

(30) Foreign Application Priority Data
Sep. 29, 2022 (FR) FR2209933

(51) Int. Cl. B64C 13/50; B64C 27/59; B64C 27/64; B64C 27/68; H02K 41/02

(52) U.S. Cl. CPC B64C 13/50; B64C 27/59; B64C 27/64; B64C 27/68; H02K 41/02

(57) ABSTRACT

A system for transmitting commands to N hydraulic servo-actuators, N≥2, includes N mechanical systems each including a rotary electric actuator including a first path including a motor and a second path including a motor; a linear electric actuator including a third path including a motor, the linear electric actuator being connected to the rotary electric actuator by a first mechanical linkage and being capable of being connected to a single hydraulic servo-actuator from among the N hydraulic servo-actuators by a second mechanical linkage; a control system including a first control device connected by an electrical connection to the first path of the rotary electric actuator of each mechanical system; a second control device connected by an electrical connection to the second path of each mechanical system; a third control device connected by an electrical connection to the third path of the linear electric actuator of each mechanical system.

### TECHNICAL FIELD OF THE INVENTION

The technical field of the invention is that of aircraft flight commands.

This invention relates to a command transmission system to a plurality of hydraulic servo-actuators.

### TECHNOLOGICAL BACKGROUND OF THE INVENTION

In the aeronautic field, flight commands of an aircraft and in particular a helicopter enable a pilot to command and modify trajectory of the helicopter along three axes: pitch, roll and yaw. In particular, the primary flight commands of a helicopter are essential to ensure safe flight and include three types of system: a command transmitting system such as rudder control pedals, a collective pitch lever and/or a throttle actuator and a cyclic stick, command receiver systems such as a main rotor (blades) and an anti-torque rotor and finally command transmission systems between the transmitter and receiver systems, wherein the transmission systems can be mechanical and hydromechanical.

Mechanical transmissions, which appeared in the first aeroplanes, are made up of cables on pulleys and/or pushrods, enabling the pilot to exert force directly on the command receiving systems, such as the rotors in a helicopter. As mechanical transmissions are more complex to set up and use in large, heavy aircraft, they have been replaced with hydromechanical transmissions and are currently only used in light aeroplanes.

A hydromechanical transmission comprises two circuits: a mechanical circuit including, for example, cables and pulleys and connecting the cockpit commands to a hydraulic circuit, the hydraulic circuit including hydraulic pumps, tanks, hoses, valves/servo-valves and hydraulic actuators. The pilot issues a command, acting on the cockpit commands, which are transmitted by the mechanical circuit to the hydraulic circuit that implements hydraulic actuators enabling the main rotor and the anti-torque rotor to move. Hydromechanical transmissions are widely used in helicopters, although a few helicopters including electric transmissions have been developed.

In contrast to aeroplanes, fly-by-wire command systems, comprising electrical, electronic and computing transmission systems, are not yet widely used in helicopters. In an aeroplane, electric, electronic and computing transmission systems transmit flight commands sent by a flight control computer (FCC) to hydraulic actuators for setting the control surfaces of the aeroplane in motion.

The use of Fly-by-Wire architecture is advantageous in aeroplanes because mechanical transmissions between the commands operated by the pilot and the control surfaces of an aircraft are replaced with electrical transmissions, thereby reducing physical efforts exerted by the pilot. In addition, the Fly-by-Wire architecture is advantageous over the mechanical and hydromechanical architectures previously mentioned because it is easy to install and set up and provides additional functions.

Thus, in a helicopter, an electrical transmission system commands the rotors via the flight control computer (FCC), which has full authority and determines their movement based on the helicopter speed, position and altitude via hydraulic actuators.

However, the use of current electronic flight commands has a major drawback: failure of the flight control computer and/or the system for electrical transmission of flight commands to the hydraulic actuators can result in the loss of the ability to command at least one axis of the helicopter, with the result that the aircraft is impaired.

There is therefore a need to find a flight command architecture that dispenses with mechanical links between the commands and the hydraulic actuators and guarantees high availability of the flight commands, so as to avoid altering the aircraft being flown, making it possible to retain the current architecture of the hydraulic actuators. In addition, the size of a helicopter requires a low overall spatial size electric flight command architecture.

### SUMMARY OF THE INVENTION

The invention offers a solution to the problems previously discussed by providing an electromechanical architecture for commanding a plurality of hydraulic servo-actuators in an aircraft, offering high flight command availability while minimising the overall size.

A first aspect of the invention relates to a command transmission system with N hydraulic servo-actuators, N being an integer greater than or equal to 2, the system including:
N mechanical systems, each mechanical system comprising:
   a rotating electric actuator including a first path comprising a motor, and a second path including a motor;
   a linear electric actuator including a third path including a motor, the linear electric actuator being linked to the rotating electric actuator by a first mechanical link and being adapted to be linked to a single hydraulic servo-actuator of the N hydraulic servo-actuators by a second mechanical link;
A command system comprising:
   a first command device linked by an electrical link to the first path of the rotating electric actuator of each mechanical system among the N mechanical systems;
   a second command device linked by an electrical link to the second path of the rotating electric actuator of each mechanical system among the N mechanical systems,
   a third command device linked by an electrical link to the third path of the linear electric actuator of each mechanical system among the N mechanical systems.

By virtue of the invention, it is possible to dispense with an entirely mechanical architecture between the cockpit commands and the hydraulic servo-actuators of a helicopter, which makes it possible to limit forces exerted by a pilot in the cockpit. The invention also makes it possible to retain the servo-actuators currently used in helicopters, thereby reducing production costs. In addition, the presence of three paths in each mechanical system advantageously ensures availability of commands in the event of failure of one or two paths. In addition, three command devices make it possible to command a plurality of N hydraulic servo-actuators, where N is greater than or equal to 2, thereby reducing the overall size of the command transmission system. The overall size of the transmission system is also reduced by virtue of the existence of three paths for two electric actuators and not three paths for three electric actuators.

In addition to the characteristics just discussed in the previous paragraph, the command transmission system according to the first aspect of the invention may have one or several complementary characteristics from among the following, considered individually or according to any technically possible combination.

According to one embodiment, N is equal to 4. Thus, three control modules enable four hydraulic servo-actuators to be commanded, each comprising three paths to which the command devices are linked, which makes it possible to reduce the overall size, for example so as not to have three control modules per hydraulic servo-actuator.

According to one embodiment, the command system is configured to operate in at least one of the following operating modes:
a so-called nominal operating mode, wherein:
   the first command device is in an operational state of validity, and is configured to:
      receive a piece of data via the first path of each mechanical system among the N mechanical systems, the piece of data relating to operating parameters of said first path of each mechanical system among the N mechanical systems;
      emit the piece of data received via the first path of each mechanical system among the N mechanical systems to a control module;
      receive a command emitted by the control module for the motor of the first path of each mechanical system among the N mechanical systems;
      emit the command to the motor of the first path of each mechanical system among the N mechanical systems;
   the second device is in a standby state of validity and is configured to:
      receive a piece of data via the second path of each mechanical system among the N mechanical systems, the piece of data relating to operating parameters of said second path of each mechanical system among the N mechanical systems;
      emit the piece of data received via the second path of each mechanical system among the N mechanical systems to the control module;
   the third command device is in an operational state of validity and is configured to:
      receive a piece of data via the third path of each mechanical system of the N mechanical systems, a piece of data relating to operating parameters of said third path of each mechanical system;
      emit each piece of data received via the third path of each mechanical system among the N mechanical systems to the control module;
      receive a command emitted by the control module to the motor of the third path of each mechanical system of the N mechanical systems, simultaneously with the step of receiving the command by the first command device,
      emit each command received to the motor of the third path of each mechanical system;
A so-called failure mode of the first command device wherein:
   the first command device is in an out-of-operation state of validity,
   the second command device is configured to change from a standby state of validity to an operational state of validity, the change of state of the second command device resulting from the out-of-operation state of validity of the first command device, and is configured to:
      receive a piece of data via the first path of each mechanical system of the N mechanical systems, the piece of data relating to operating parameters of said first path of each mechanical system of the N mechanical systems;
      emit the piece of data received via the first path of each mechanical system among the N mechanical systems to the control module;
      receive by the control module a command to be emitted to the motor of the second path of each mechanical system among the N mechanical systems;
      emit the command to the motor of the second path of each mechanical system among the N mechanical systems;
   the third command device is in an operational state of validity and is configured to:
      receive a piece of data via the third path of each mechanical system among the N mechanical systems, the second piece of data relating to operating parameters of said third path of each mechanical system among the N mechanical systems;
      emit the piece of data received via the third path of each mechanical system among the N mechanical systems to the control module;
      receive by the control module, simultaneously with receiving each command by the second command device, a command to be emitted to the motor of the third path of each mechanical system among the N mechanical systems;
      emit the command to the motor of the third path of each mechanical system among the N mechanical systems;
A so-called failure mode of the third command device wherein:
   the first command device is in an operational state of validity, and is configured to:
      receive a piece of data via the first path of each mechanical system among the N mechanical systems, the piece of data relating to operating parameters of said first path;
      emit the piece of data received via the first path of each mechanical system among the N mechanical systems to the control module;
      receive by the control module at least one command to be emitted to the motor of the first path of each mechanical system among the N mechanical systems;
      emit the command to the motor of the first path of each mechanical system among the N mechanical systems;
   the second command device is in a standby state of validity and is configured to:
      receive at least one piece of data via the second path, the piece of data relating to operating parameters of said second path;
      emit the piece of data received via the second path of each mechanical system among the N mechanical systems to the control module;
   the third command device is in an out-of-operation state;
      for each operating mode, the sum of the command received respectively by the motor of the first path or the motor of the second path and/or the motor of the third path of each mechanical system among the N mechanical systems ensures mechanical command of the hydraulic servo-actuator linked to said mechanical system. Advantageously, the command transmission system adapts in the event of a failure of one of the command devices, enabling each hydraulic servo-actuator of the N hydraulic servo-actuators to continue to be commanded despite a failure of one of the command devices and therefore despite a break in an electrical link with one of the three paths or with two paths, a first of which is included in the rotating actuator and a second of which is included in the linear actuator.

According to one embodiment, for each mechanical system among the N mechanical systems:
the first path comprises a motor position sensor and a rotating position sensor;
The second path comprises a motor position sensor and a rotating position sensor;
the third path comprises a third motor position sensor and a linear position sensor;
   and wherein a piece of data received via a path among the first, second and third paths relating to the operating parameters of that path comprises:
a piece of data relating to the position of the motor in the path and/or
a piece of data relating to the position of the actuator in which said path is included.

According to one embodiment, a command emitted by the control module to a command device comprises a position instruction intended for the motor in each path linked to said command device.

According to one embodiment, the rotating actuator of each mechanical system among the N mechanical systems is irreversible.

According to one embodiment, the linear actuator of each mechanical system among the N mechanical systems is irreversible.

According to one embodiment, for each mechanical system among the N mechanical systems, the first mechanical link and the second mechanical link are in series.

A second aspect of the invention relates to a command assembly with N hydraulic servo-actuators characterised in that it comprises:
a control module;
a command transmission system according to the first aspect of the invention.
N hydraulic servo-actuators.

A third aspect of the invention relates to an aircraft comprising a command assembly according to the second aspect of the invention.

The invention and its various applications will be better understood upon reading the following description and upon examining the accompanying figures.

### BRIEF DESCRIPTION OF THE FIGURES

The figures are set forth by way of indicating and in no way limiting purposes of the invention.

FIG. 1 shows a schematic representation of a command assembly with N=4 hydraulic servo-actuators.

FIG. 2 shows a diagram of a rotating electric actuator included in a mechanical system.

FIG. 3 shows a diagram of an electric linear actuator included in a mechanical system.

FIG. 4 shows a diagram of a command device.

FIG. 5 is a diagram of the command assembly with N=4 hydraulic servo-actuators when the transmission system according to the invention is in a so-called nominal operating mode;

FIG. 6 is a diagram of the command assembly with N=4 hydraulic servo-actuators when the transmission system according to the invention is in a so-called failure operating mode of the first command device;

FIG. 7 is a diagram of the command assembly with N=4 hydraulic servo-actuators when the transmission system according to the invention is in a so-called failure operating mode of the third command device.

### DETAILED DESCRIPTION

Unless otherwise specified, a same element appearing in different figures has a single reference.

One aspect of the invention relates to a command assembly with N hydraulic servo-actuators.

Preferably, the command assembly is included in an aircraft.

Preferably, the aircraft is a helicopter.

N is an integer greater than or equal to 2, for example equal to 3, preferably equal to 4.

The command assembly comprises a control module, a command transmission system according to the invention and N hydraulic servo-actuators.

The control module comprises at least one calculator and at least one power supply.

Preferably, the control module comprises four calculators.

Each calculator comprises a processor.

Preferably each calculator is a Flight Control Computer (FCC).

The power supply preferably comprises first and second outputs each configured to deliver a voltage, preferably a DC voltage.

Preferably, the voltage value delivered by the first output and/or the second output is 28 volts.

In particular, the command transmission system includes a command system and includes N mechanical systems having identical architecture.

The command system of the command transmission system includes first, second and third command devices.

Each mechanical system among the N mechanical systems of the command transmission system comprises a rotating electric actuator and a linear electric actuator.

Preferably, the rotating electric actuator of each mechanical system among the N mechanical systems has an identical architecture to the other rotating electric actuators of the other mechanical systems.

Preferably, the linear electric actuator of each mechanical system among the N mechanical systems has an identical architecture to the other linear actuators of the other mechanical systems.

The rotating electric actuator of each mechanical system among the N mechanical systems comprises a first path linked by an electrical link to the first command device. Said electrical link comprises at least one electrical signal. The electrical signal may be digital or analogue.

The rotating electric actuator of each mechanical system among the N mechanical systems further comprises a second path linked by an electrical link to the second command device. Said electrical link comprises at least one electrical signal. The numerical signal may be digital or analogue.

The linear electric actuator of each mechanical system among the N mechanical systems comprises a third path linked by an electrical link to the third command device. The third electrical link comprises at least one electrical signal. The electrical signal may be digital or analogue.

Thus the first command device is linked to the first path of the rotating actuator of each mechanical system among the N mechanical systems.

Thus the second command device is linked to the second path of the rotating actuator of each mechanical system among the N mechanical systems.

Thus the third command device is linked to the third path of the linear actuator of each mechanical system among the N mechanical systems.

For each mechanical system among the N mechanical systems, the rotating actuator of said mechanical system is linked by a first mechanical link to the linear electric actuator of said mechanical system and the linear actuator linked by a second mechanical link to a single hydraulic servo-actuator among the N hydraulic servo-actuators. By “linear actuator linked by a second mechanical link to a single servo-actuator”, it is meant a linear actuator linked to a hydraulic servo-actuator to which no other linear actuator is linked with the exception of the linear actuator under consideration. Thus each hydraulic servo-actuator under consideration is linked only to the linear actuator under consideration.

Thus, each mechanical system among the N mechanical systems is linked to a single hydraulic servo-actuator among the N hydraulic servo-actuators. By “each mechanical system among the N mechanical systems is linked to a single hydraulic servo-actuator among the N hydraulic servo-actuators”, it is meant that each mechanical system is linked to a single hydraulic servo-actuator to which no other mechanical system is linked with the exception of the mechanical system under consideration. Thus each servo-actuator is linked to only one mechanical system.

For each mechanical system among the N mechanical systems, the first mechanical link is preferably a pivot connection and the second mechanical link is preferably a pivot connection. Preferably, the first mechanical link and the second mechanical link are in series.

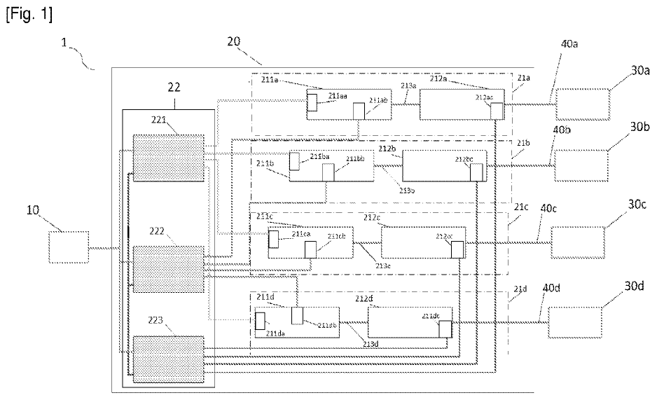

FIG. 1 shows one embodiment of the command assembly 1 in the case N=4. Thus, the command assembly comprises the control module 10, the command transmission system 20 and four hydraulic servo-actuators 30a, 30b, 30c and 30d having identical architecture.

With reference to FIG. 1, the command transmission system 20 includes the command system 22 including the first 221, second 222 and third 223 command devices.

With reference to FIG. 1, the command transmission system comprises N=4 mechanical systems 21a, 21b, 21c and 21d having identical architecture.

With reference to FIG. 1, each mechanical system 21a, 21b, 21c and 21d comprises a rotating electric actuator 211a, 211b, 211c and 211d respectively and comprises a linear electric actuator 212a, 212b, 212c and 212d respectively.

According to the embodiment of FIG. 1, each rotating electric actuator 211a, 211b, 211c and 211d comprises a first path 211aa, 211ba, 211ca and 211da respectively.

According to the embodiment of FIG. 1, each rotating electric actuator 211a, 211b, 211c and 211d comprises a second path 211ab, 211bb, 211cb and 211db respectively.

Each first path 211aa, 211ba, 211ca, 211da is electrically linked to the first command device 221.

Each second path 211ab, 211bb, 211cb, 211db is electrically linked to the second command device 222.

In the embodiment of FIG. 1, each rotating linear actuator 212a, 212b, 212c and 212d comprises a third path 212aa, 212ba, 212ca and 212da respectively.

Each third path 212aa, 212ba, 212ca and 212da is electrically linked to the third command device 223.

According to the embodiment of FIG. 1, the rotating electric actuator 211a of the mechanical system 21a is linked by a first mechanical link 213a to the linear electric actuator 212a of the same mechanical system 21a, and said linear electric actuator 212a is linked by a second mechanical link 40a to the hydraulic servo-actuator 30a.

According to the embodiment of FIG. 1, the rotating electric actuator 211b of the mechanical system 21b is linked by a first mechanical link 213b to the linear electric actuator 212b of the same mechanical system 21b, and said linear electric actuator 212b is linked by a second mechanical link 40b to the hydraulic servo-actuator 30b.

According to the embodiment of FIG. 1, the rotating electric actuator 211c of the mechanical system 21c is linked by a first mechanical link 213c to the linear electric actuator 212c of the same mechanical system 21c, and said linear electric actuator 212c is linked by a second mechanical link 40c to the hydraulic servo-actuator 30c.

According to the embodiment of FIG. 1, the rotating electric actuator 211d of the mechanical system 21d is linked by a first mechanical link 213c to the linear electric actuator 212d of the same mechanical system 21d, and said linear electric actuator 212d is linked by a second mechanical link 40d to the hydraulic servo-actuator 30d.

As each rotating electric actuator 211a, 211b, 211c and 211d has an identical architecture, only the architecture of the rotating electric actuator 211a will be detailed in the following.

In particular, each rotating electric actuator of each mechanical system among the N mechanical systems has an architecture identical to the architecture of the rotating actuator 211a.

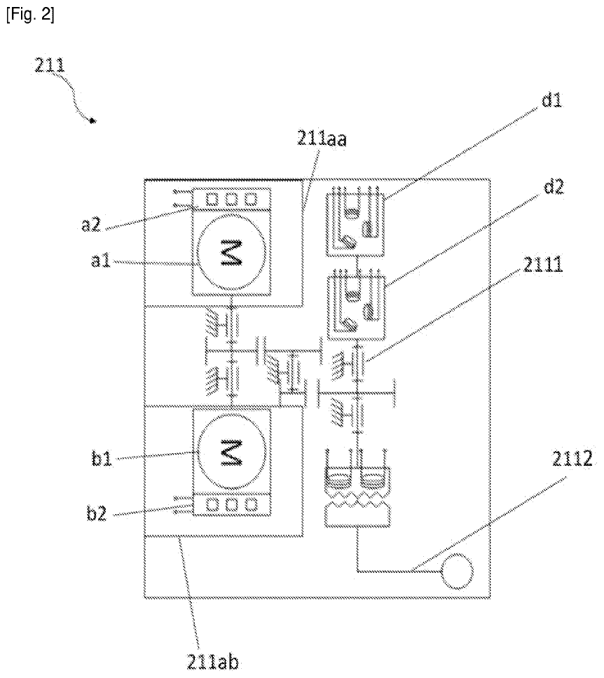

FIG. 2 is a schematic representation of the rotating electric actuator 211a. The rotating actuator 211a comprises the first path 211aa and the second path 211ab.

The rotating electric actuator 211 may comprise a first reducer 2111 and an output shaft 2112.

The first path 211aa of the rotating actuator 211a comprises a motor a1, preferably a brushless motor, and a motor position sensor a2, configured to measure position of the motor a1 of the first path 211aa.

Preferably, the motor a1 of the first path 211aa is a three-phase motor and comprises three three-phase inputs, not represented in FIG. 2.

Preferably, the motor position sensor a2 of the first path 211aa is a Hall effect sensor.

The second path 211ab of the actuator 211a comprises a motor b1, preferably a brushless motor, and a motor position sensor b2, configured to measure position of the motor b1 of the second path 211ab.

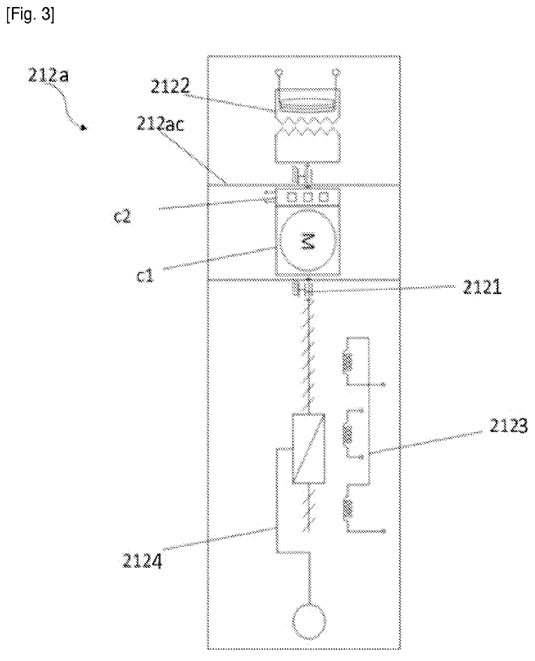

Preferably the motor b1 of the second path 211ab is a three-phase motor and comprises three three-phase inputs, not represented in FIG. 3.

Preferably, the motor position sensor b2 of the second path 211ab is a Hall effect sensor. The output shaft 2112 preferably comprises a first angular position sensor d1, a second angular position sensor d2, a brake d3, preferably a dual-feed electrically actuated dog clutch brake.

Preferably the first angular position sensor d1 is linked to the first path 211aa, and the second angular position sensor d2 is linked to the second path 211ab. The rotating actuators 211b, 211c and 211d each have the same architecture as that described for 211a.

According to one embodiment not represented in FIG. 2, the first angular position sensor d1 is included in the first path 211aa, and the second angular position sensor d2 is included in the second path 211ab.

The brake d3 is preferably a no-current brake.

The first and second angular position sensors (d1, d2) are configured to measure position of the rotating electric actuator 211a.

When the output shaft 2112 comprises the dual-feed electrically actuated dog clutch brake, said clutch brake ensures irreversibility of the rotating actuator 211a.

As each linear electric actuator 212a, 212b, 212c and 212d has a preferably identical architecture, only the architecture of the linear electric actuator 212a will be detailed in the following.

In particular, each linear electric actuator of each mechanical system of the N mechanical systems has an architecture identical to the architecture of the linear actuator 212a.

FIG. 3 is a schematic representation of the electric linear actuator 212a.

The electric linear actuator 212a comprises the third path 212ac.

The electric linear actuator 212 may comprise a reducer 2121, a brake 2122, a linear position sensor 2123 and a ball screw 2124.

Brake 2122 is preferably a dual-feed electrically actuated dog clutch brake.

Brake 2122 is preferably a no-current brake.

When the electric linear actuator 212a comprises the electrically actuated dog clutch brake, the electric linear actuator 212a is irreversible.

The third path 212ac of the electric linear actuator 212 comprises a motor c1, preferably a brushless motor, and a motor position sensor c2 configured to measure position of the motor c1.

Preferably the motor c1 of the third path 212ac is a three-phase motor and comprises a three-phase input, not represented in FIG. 3.

Preferably, the motor position sensor c2 of the third path 212ac is a Hall effect sensor. According to one embodiment, the linear position sensor 212d is included in the third path 212c.

The first, second and third command devices of the command system for each mechanical system among the N mechanical systems preferably have an identical architecture.

Each command device of the command transmission system comprises a command module, a processing module and N actuation modules.

The command device can include a filtering module.

The command module may comprise first and second power supply ports each configured to receive an electrical voltage, preferably a DC voltage with a value of 28V.

The command module comprises at least one command port. Preferably, the command port is adapted to be linked by an electrical link to the calculator of the control module and is adapted to receive electrical commands.

According to the embodiment in which the control module comprises four calculators, the control module comprises four command ports, each command port of which is adapted to be electrically linked respectively to a single one of the four calculators.

By “each command port is adapted to be electrically linked respectively to a single calculator among the four calculators”, it is meant that each command port is linked to a calculator to which no command port is linked with the exception of the mechanical system under consideration.

The control module may further comprise a Data Serial Input (DSI) port and a Data Serial Output (DSO) port.

The serial input data port is configured to receive an enable or disable signal from the associated calculator, for example. As regards the serial output data port, it can be configured to emit a signal to another calculator.

According to one embodiment, the command module comprises a communication port. Said communication port is configured to receive software instructions, for example.

The filtering module is adapted to receive one or more electrical signals from the control module and to filter them, for example in order to reduce noise included in the one or more electrical signals received.

The processing module is preferably a processor with N logic cores.

The processing module is configured to process signals received by the control module and to transmit them to each actuation module among the N actuation modules.

When each of the first, second, and third command devices comprises the filtering module, the processing module is configured to process electrical signals emitted by the filtering module and to transmit them to each actuation module among the N actuation modules.

The processing module is further configured to process signals received by each actuation module among the N actuation modules and transmit them to the command module.

Each actuation module among the N actuation modules is adapted to be linked to a single path of one mechanical system among the N mechanical systems.

In particular, each actuation module among the N actuation modules comprises a motor driver module, a data reception module and a brake driver module.

The motor driver module of one of the N actuation modules is adapted to command the motor in the path to which the actuation module is linked.

The motor driver module comprises a three-phase output, the three-phase output including three electric currents, preferably three DC electric currents.

The brake driver module provides a two-phase output, the two-phase output including two electric currents, preferably two DC electric currents.

The data reception module preferably comprises a first port and a second port. The first port of the data receiving module is adapted to receive data from the motor position sensor included in the path to which the actuation module is linked, and the second port of the data receiving module is adapted to receive data from the position sensor of the actuator comprising the path to which the actuation module is linked.

Advantageously, a single command device makes it possible to communicate and emit commands to N paths to which it is linked.

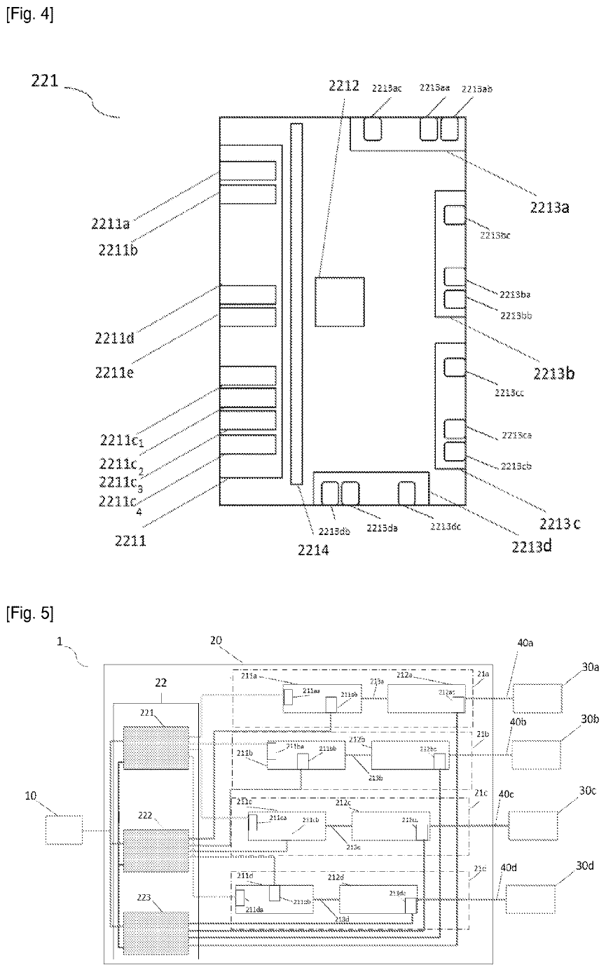

FIG. 4 is one embodiment of the first command device 221, in the case N=4. As the architecture of the first 221, second 222 and third 223 command devices is identical, only the first command device 221 is represented.

Thus, in this embodiment, the command device 221 represented comprises the command module 2211, the filtering module 2214, the processing module 2212 and N =4 actuation modules 2213a, 2213b, 2213c, 2213d.

The four actuation modules 2213a, 2213b, 2213c, 2213d preferably have identical architectures.

With reference to FIG. 4, the command module 2211 comprises four command ports 2211c, the data serial input port 2211d and the data serial output port 2211e. The control module 211 further comprises the first 2211a and second 2211b power supply ports configured to receive an electrical voltage, preferably a DC voltage with a value of 28V.

With reference to FIG. 4, the actuation module 2213a comprises the motor driver module 2213aa, the data reception module 2213ab and the brake driver module 2213ac.

With reference to FIG. 4, the actuation module 2213b comprises the motor driver module 2213ba, the data reception module 2213bb and the brake driver module 2213bc.

With reference to FIG. 4, the actuation module 2213c comprises the motor driver module 2213ca, the data reception module 2213cb and the brake driver module 2213cc. The command devices 222 and 223 have an architecture identical to the architecture described for the command device 221.

The transmission system according to the invention operates according to at least one of the following operating modes: so-called nominal operating mode, so-called failure operating mode of the first command device and so-called failure operating mode of the third command device.

During each operating mode of the operating modes recited, the command devices can each be in one of at least three states of validity: operational state of validity, standby state of validity, faulty state of validity.

An operational state of validity of a command device is defined as a state of validity during which the command device is configured to implement a plurality of operational steps described below.

A first operational step is a step of receiving, by the command device, at least one piece of data via each path linked to said command device, via the data reception module of the actuation module linked to said path, a piece of data relating to operating parameters of said path.

The piece of data relating to the operating parameters of each path linked to said command device comprises a piece of data relating to the position of the motor of the path linked to the command device and/or a piece of data relating to the position of the electric actuator comprising the path linked to the command device.

The piece of data relating to the position of the motor of the path linked to said command device is measured by the motor position sensor of said path.

The piece of data relating to the position of the actuator of the path linked to said command device is measured by the rotating or linear position sensor of the actuator comprising said path.

A second operational step is a step of emitting, to the control module and in particular to the at least one calculator, via the command port, the piece of data relating to the operating parameters.

A third operational step is a step of receiving a command sent by the at least one calculator, via the command port, to the motor of each path linked to the command device.

The command intended for the motor of each path linked to the command device is preferably a position command for said motor. Preferably, the position command for said motor is a real value, preferably having a mm unit.

A fourth operational step is a step of emitting, by the processing module of the command device, the command to the motor included in each path linked to the command device.

By standby state of validity of a command device, it is meant a state during which the command device is configured to implement standby steps.

A first standby step is a step of receiving, by the command device, a piece of data via each path linked to said command device, via the data reception module, the piece of data relating to operating parameters of said path.

The piece of data relating to the operating parameters of each path comprises a piece of data relating to the position of the first motor included in the path linked to said command device and/or a piece of data relating to the position of the actuator comprising the path linked to said command device.

A second standby step is a step of transmitting to the control module, via the command port, the piece of data relating to the operating parameters received via each path linked to said command device.

By faulty state of validity of a command device, it is meant a state of validity during which the electrical link between said command device and each path to which it is linked is broken and no communication between the two is possible.

In the following, “command device in an operational state of validity” and “operational command device” will be used interchangeably.

In the following, “command device in a standby state of validity” and “command device in standby” will be used interchangeably.

In the following, “command device in a faulty state of validity” and “faulty command device” will be used interchangeably.

Each of the first, second and third command devices is configured to communicate its state of validity to the other devices via the command module and more specifically via the serial output data port.

Each of the first, second and third command devices is configured to receive the state of validity of the other devices via the control module and more specifically via the serial input data port.

Each of the first, second and third command devices is configured to communicate its state of validity to the control module via the command port adapted to connect the command device to said calculator.

The control module emits N commands to each command device being in an operational state of validity, the command being intended for the motor of each path linked to said device. Preferably, each command device being in an operational state of validity receives N commands, simultaneously with the other command devices being in an operational state of validity.

Each command of the N commands received by an operational command device is intended for a single hydraulic servo-actuator of the N hydraulic servo-actuators. Thus, each hydraulic servo-actuator receives a command among the N commands.

Preferably, each command among the N commands comprises a fraction of the desired position value for the hydraulic servo-actuator for which said command is intended.

Preferably, the fraction of the desired position value of each hydraulic servo-actuator among the N hydraulic servo-actuators is determined on the basis of a desired position value of said hydraulic servo-actuator and the number of operational command devices.

For example, the fraction of the desired position value for each hydraulic servo-actuator among the N hydraulic servo-actuators is obtained by dividing the desired position value of said hydraulic servo-actuator by the number of operational command devices.

Thus, the command of each hydraulic servo-actuator among the N hydraulic servo-actuators results from the sum of the values included in the commands respectively received by each operational command device and emitted to the mechanical system among the N mechanical systems linked to said hydraulic servo-actuator.

FIG. 5 represents one embodiment of the command assembly 1 for N=4 and when the transmission system according to the invention is operating in a so-called nominal operating mode.

According to the nominal operating mode, the first command device 221 is operational, the second command device 222 is in standby and the third command device 223 is operational.

For example, when the operating mode of the transmission system 20 according to the invention is said to be nominal, in order to move each hydraulic servo-actuator by a value equal to X, the control module 10 sends N=4 first commands to the first command device 221 operational, each first command among the N=4 first commands comprising a position value equal to X/2 and N second commands to the third command device 223 operational, each second command among the N=4 second commands comprising a value equal to X/2. Preferably, the N=4 first commands and the N=4 second commands are simultaneously emitted.

In particular, the motor of the first path 211aa of the mechanical system 21a receives a position command whose value is equal to X/2, allowing the rotating actuator 211a to move by a value equal to X/2 and to set the linear actuator 212a of the mechanical system 21a in motion by means of the first mechanical link 213a. In addition, the motor of the third path 212ac receives, simultaneously with receiving the command by the motor of the first path 211aa, a position command emitted by the control module whose value is equal to X/2, allowing the linear actuator 212a to move by a value equal to X/2. Thus, the linear actuator 212a receives an electrical command having value X/2, and a mechanical command having value X/2, the linear actuator thus moves by a value X and makes it possible to move, via the second mechanical link 40a, the hydraulic servo-actuator 30a, linked to the mechanical system 12a, by a value X.

In particular, the motor of the first path 211ba of the mechanical system 21b receives a position command whose value is equal to X/2, allowing the rotating actuator 211b to move by a value equal to X/2 and to set the linear actuator 212b of the mechanical system 21b in motion by means of the first mechanical link 213b. In addition, the motor of the third path 212bc receives, simultaneously with receiving the command by the motor of the first path 211ba, a position command emitted by the control module whose value is equal to X/2, allowing the linear actuator 212b to move by a value equal to X/2. Thus, the linear actuator 212b receives an electrical command having value X/2, and a mechanical command having value X/2, the linear actuator thus moves by a value X and allows the hydraulic servo-actuator 30b, linked to the mechanical system 12b, to move by a value X via the second mechanical link 40b.

In particular, the motor of the first path 211ca of the mechanical system 21c receives a position command whose value is equal to X/2, allowing the rotating actuator 211c to move by a value equal to X/2 and to set the linear actuator 212c of the mechanical system 21c in motion by means of the first mechanical link 213c. In addition, the motor of the third path 212cc receives, simultaneously with receiving the command by the motor of the first path 211ca, a position command emitted by the control module whose value is equal to X/2, allowing the linear actuator 212c to move by a value equal to X/2. Thus, the linear actuator 212c receives an electrical command having value X/2, and a mechanical command having value X/2, the linear actuator thus moves by a value X and makes it possible to move, via the second mechanical link 40c, the hydraulic servo-actuator 30c, linked to the mechanical system 12c, by a value X.

In particular, the motor of the first path 211da of the mechanical system 21d receives a position command whose value is equal to X/2, allowing the rotating actuator 211d to move by a value equal to X/2 and to set the linear actuator 212c of the mechanical system 21d in motion by means of the first mechanical link 213d. In addition, the motor of the third path 212dc receives, simultaneously with receiving the command by the motor of the first path 211da, a position command emitted by the control module, the value of which is equal to X/2, enabling the linear actuator 212d to move by a value equal to X/2. Thus, the linear actuator 212d receives an electrical command having value X/2, and a mechanical command having value X/2, the linear actuator thus moves by a value X and allows the hydraulic servo-actuator 30d, linked to the mechanical system 12d to move, via the second mechanical link 40d, by a value X.

X can be a value in millimetres in the range [−35 mm, 35 mm].

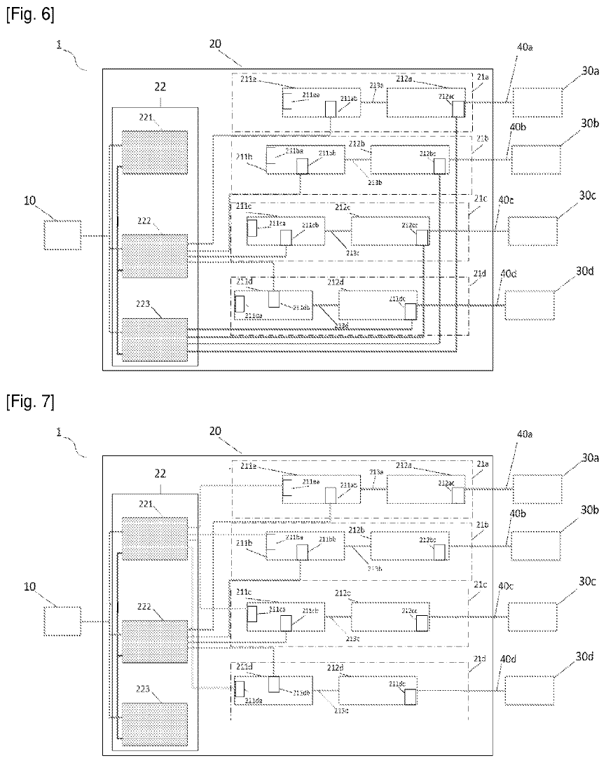

FIG. 6 represents the command assembly 1, when the system according to the invention is operating according to a so-called failure mode of the first command device 211, for N=4.

According to the so-called failure operating mode of the first command device 221, the first command device 221 is in a faulty state of validity, the second command device 222 is configured to change from a standby state of validity to an operational state of validity, the change of state of the second command device 222 resulting from the non-operational state of validity of the first command device 221, and the third command device 223 is in an operational state of validity.

For example, when the operating mode of the transmission system 20 according to the invention is said to be failure of the first device 221, in order to move each hydraulic servo-actuator 30a, 30b, 30c, and 30d by a value equal to X, the control module 10 sends N=4 first commands to the second command device 222 operational, each first command comprising a value equal to X/2 sends N second commands to the third command device 223 operational, each second command comprising a value equal to X/2.

In particular, the motor of the second path 211ab of the mechanical system 211a receives a position command whose value is equal to X/2, allowing the rotating actuator 211a to move by a value equal to X/2 and to set the linear actuator 212a in motion by means of the first mechanical link 231a. In addition, the motor of the third path 212ac receives, simultaneously with receiving the command by the motor of the second path 211ab, a position command whose value is equal to X/2, allowing the linear actuator 212a to move by a value equal to X/2. Thus, the linear actuator 212a receives an electrical command having value X/2, and a mechanical command having value X/2, the linear actuator 212a thus moves by a value X and allows the hydraulic servo-actuator 30a to move by a value X via the second mechanical link 40a.

In particular, the motor of the second path 211bb of the mechanical system 211b receives a position command whose value is equal to X/2, allowing the rotating actuator 211b to move by a value equal to X/2 and to set the linear actuator 212b in motion by means of the first mechanical link 231b. In addition, the motor of the third path 212bc receives, simultaneously with receiving the command by the motor of the second path 211bb, a position command whose value is equal to X/2, allowing the linear actuator 212b to move by a value equal to X/2. Thus, the linear actuator 212b receives an electrical command having value X/2, and a mechanical command having value X/2, the linear actuator 212b thus moves by a value X and allows the hydraulic servo-actuator 30b to move by a value X via the second mechanical link 40b.

In particular, the motor of the second path 211cb of the mechanical system 211c receives a position command whose value is equal to X/2, allowing the rotating actuator 211c to move by a value equal to X/2 and to set the linear actuator 212c in motion by means of the first mechanical link 231c. In addition, the motor of the third path 212cc receives, simultaneously with receiving the command by the motor of the second path 211cb, a position command whose value is equal to X/2, allowing the linear actuator 212c to move by a value equal to X/2. Thus, the linear actuator 212c receives an electrical command having value X/2, and a mechanical command having value X/2, the linear actuator 212c thus moves by a value X and allows the hydraulic servo-actuator 30c to move by a value X via the second mechanical link 40c.

In particular, the motor of the second path 211db of the mechanical system 211d receives a position command whose value is equal to X/2, allowing the rotating actuator 211d to move by a value equal to X/2 and to set the linear actuator 212d in motion by means of the first mechanical link 231d. In addition, the motor of the third path 212dc receives, simultaneously with receiving the command by the motor of the second path 211db, a position command whose value is equal to X/2, allowing the linear actuator 212d to move by a value equal to X/2. Thus, the linear actuator 212d receives an electrical command having value X/2, and a mechanical command having value X/2, the linear actuator 212d thus moves by a value X and allows the hydraulic servo-actuator 30d to move by a value X via the second mechanical link 40d.

X can be a value in millimetres in the range [−35 mm, 35 mm].

FIG. 7 represents the command assembly 1, when the system according to the invention is operating according to a so-called failure mode of the third command device 223.

According to the so-called failure operating mode of the third command device 223, the first command device 221 is in an operational state of validity, the second command device 222 is in a standby state of validity and the third command device 223 is in a faulty state of validity.

For example, when the operating mode of the transmission system 20 according to the invention is said to be nominal, in order to move each hydraulic servo-actuator by a value equal to X, the control module sends N commands, each command among the N commands comprises a value equal to X to the first command device 221 operational.

In particular, the motor of the first path 211a receives a position command whose value is equal to X, allowing the rotating actuator 211a to move by a value equal to X and to set the linear actuator 212a in motion by means of the first mechanical link. In this operating mode, the linear actuator 212a only receives a mechanical position command, equal to X. The linear actuator 212a thus moves by a value X and allows the hydraulic servo-actuator 30a to move by a value X via the second mechanical link 40a.

In particular, the motor of the first path 211b receives a position command whose value is equal to X, allowing the rotating actuator 211b to move by a value equal to X and to set the linear actuator 212b in motion by means of the first mechanical link. In this operating mode, the linear actuator 212b only receives one mechanical position command, equal to X. The linear actuator 212b thus moves by a value X and allows the hydraulic servo-actuator 30b to move by a value X via the second mechanical link 40b.

In particular, the motor of the first path 211c receives a position command whose value is equal to X, allowing the rotating actuator 211c to move by a value equal to X and to set the linear actuator 212c in motion by means of the first mechanical link. In this operating mode, the linear actuator 212c only receives a mechanical position command, equal to X. The linear actuator 212c thus moves by a value X and allows the hydraulic servo-actuator 30c to move by a value X via the second mechanical link 40c.

In particular, the motor of the first path 211d receives a position command whose value is equal to X, allowing the rotating actuator 211d to move by a value equal to X and to set the linear actuator 212d in motion by means of the first mechanical link. In this operating mode, the linear actuator 212d only receives one mechanical position command, equal to X. The linear actuator 212d thus moves by a value X and allows the hydraulic servo-actuator 30d to move by a value X via the second mechanical link 40a.

X can be a value in millimetres in the range [−35 mm, 35 mm].

1. A command transmission system with N hydraulic servo-actuators N being an integer greater than or equal to 2, the system including:
N mechanical systems each mechanical system comprising:
a rotating electric actuator including a first path, including a motor, and a second path including a motor;
a linear electric actuator, including a third path including a motor, the linear electric actuator, being linked to the rotating electric actuator, by a first mechanical link and being adapted to be linked to a single hydraulic servo-actuator of the N hydraulic servo-actuators by a second mechanical link;
a command system comprising:
a first command device linked by an electrical link to the first path, of the rotating electric actuator of each mechanical system among the N mechanical systems
a second command device linked by an electrical link to the second path of the rotating electric actuator of each mechanical system among the N mechanical systems
a third command device linked by an electrical link to the third path of the linear electric actuator of each mechanical system among the N mechanical systems.

2. The command transmission system according to claim 1, wherein N is equal to 4.

3. The command transmission system according to claim 1 wherein the command system is configured to operate according to a nominal operating mode, wherein:
the first command device is in an operational state of validity, and is configured to:
receive a piece of data via the first path of each mechanical system among the N mechanical systems, the piece of data relating to operating parameters of said first path of each mechanical system among the N mechanical systems;
emit the piece of data received via the first path of each mechanical system among the N mechanical systems to a control module;
receive a command emitted by the control module intended for the motor of the first path of each mechanical system among the N mechanical systems
emit the command to the motor of the first path of each mechanical system among the N mechanical systems
the second command device is in a standby state of validity and is configured to:
receive a piece of data via the second path of each mechanical system among the N mechanical systems, a piece of data relating to operating parameters of said second path of each mechanical system among the N mechanical systems;
emit the piece of data received via the second path of each mechanical system among the N mechanical systems, to the control module;
the third command device is in an operational state of validity and is configured to:
receive a piece of data via the third path of each mechanical system among the N mechanical systems, a piece data relating to operating parameters of said third path of each mechanical system among the N mechanical systems
emit each piece of data received via the third path of each mechanical system among the N mechanical systems to the control module;
receive a command emitted by the control module intended for the motor of the third path of each mechanical system among the N mechanical systems simultaneously with the step of receiving the command by the first command device
emit each command received to the motor of the third path of each mechanical system.

4. The command transmission system according to claim 1 wherein the command system is configured to operate according to a failure mode of the first command device, wherein:
the first command device is in an out-of-operation state of validity,
the second command device is configured to change from a standby state of validity to an operational state of validity, the change of state of the second command device resulting from the out-of-operation state of validity of the first command device, and is configured to:
receive a piece of data via the first path of each mechanical system among the N mechanical systems, the piece of data relating to operating parameters of said first path of each mechanical system among the N mechanical systems;
emit the piece of data received via the first path of each mechanical system among the N mechanical systems to the control module;
receive by the control module a command to emit to the motor of the second path of each mechanical system among the N mechanical systems;
emit the command to the motor of the second path of each mechanical system among the N mechanical systems;
the third command device is in an operational state of validity and is configured to:
receive a piece of data via the third path of each mechanical system of the N mechanical systems, the second piece of data relating to operating parameters of said third path of each mechanical system of the N mechanical systems;
emit to the control module the piece of data received via the third path of each mechanical system among the N mechanical systems;
receive by the control module, simultaneously with receiving each command by the second command device a command to be emitted to the motor of the third path of each mechanical system among the N mechanical systems;
emit the command to the motor of the third path of each mechanical system among the N mechanical systems.

5. The command transmission system according to claim 1, wherein the command system is configured to operate according to a failure mode of the third command device wherein:
the first command device is in an operational state of validity, and is configured to:
receive a piece of data via the first path of each mechanical system of the N mechanical systems the piece of data relating to operating parameters of said first path;
emit the piece of data received via the first path of each mechanical system among the N mechanical systems to the control module;
receive by the control module at least one command to be emitted to the motor of the first path of each mechanical system among the N mechanical systems;
emit the command to the motor of the first path of each mechanical system among the N mechanical systems;
the second command device is in a standby state of validity and is configured to:
receive at least one piece of data via the second path, the piece of data relating to operating parameters of said second path;
emit the piece of data received via the second path of each mechanical system among the N mechanical systems to the control module;
the third command device is in an out-of-operation state.

6. The command transmission system according to claim 3, wherein, for each operating mode, the sum of the command received respectively by the motor of the first path or the motor of the second path and/or the motor of the third path of each mechanical system among the N mechanical systems provides mechanical command of the hydraulic servo-actuator linked to said mechanical system.

7. The command transmission system according to claim 3 wherein, for each mechanical system among the N mechanical systems:
the first path comprises a motor position sensor and a rotating position sensor;
the second path comprises a motor position sensor and a rotating position sensor;
the third path comprises a third motor position sensor and a linear position sensor;
and wherein a piece of data received via a path among the first, second and third paths relating to the operating parameters of that path comprises:
a piece of data relating to the position of the motor included in the path and/or
a piece of data relating to the position of the actuator in which said path is included.

8. The command transmission system according to claim 2, wherein a command emitted by the control module to a command device comprises a position instruction intended for the motor included in each path linked to said command device.

9. The command transmission system according to claim 1, wherein the rotating actuator of each mechanical system among the N mechanical systems is irreversible.

10. The command transmission system according to claim 1 wherein the linear actuator of each mechanical system among the N mechanical systems is irreversible.

11. The command transmission system according to claim 1 wherein, for each mechanical system of the N mechanical systems the first mechanical link and the second mechanical link are in series.

12. A command assembly for N hydraulic servo-actuators, comprising:
a control module
a command transmission system according to claim 1;
N hydraulic servo-actuators.

13. An aircraft comprising a command assembly according to the claim 12.
